(19) United States
(12) Patent Application Publication
(10) Pub. No.: US 2012/0036054 A1
(43) Pub. Date: Feb. 9, 2012

(54) Method for tagging documents and communications with filing and billing information

(76) Inventor: Thomas Zuber, Los Angeles, CA (US)

(21) Appl. No.: 13/278,127

(22) Filed: Oct. 20, 2011

Related U.S. Application Data
(63) Continuation of application No. 13/011,655, filed on Jan. 21, 2011.
Application No. 13/011,655 is a continuation-in-part of application No. 12/575,442, filed on Oct. 7, 2009.

(51) Int. Cl. G06Q 30/04

(52) U.S. Cl. 705/34

(57) ABSTRACT

A method for tagging documents and communications with filing and billing information in the context of an online social network. As the documents and communication are created an automatic tagging tool associates the created document or communication with a preselected set of information that corresponds to the document or communication, the social network member who made the creation, and the client for whom the work was performed. The information to be associated with each document and communication can be customized to include categories most applicable to the business of the user.

### CROSS REFERENCE TO RELATED APPLICATIONS

This application is a Continuation of prior application No. 13/011,655, which in turn claims benefit as a Continuation-In-Part under 35 U.S.C. §120 to U.S. patent application Ser. No. 12/575,442, filed Oct. 7, 2009, titled “System and Method for Interactively Collaborating Within a Secure Online Social Networking Community.” The contents of each of these applications are incorporated herein in their entirety by reference.

This application is also related to commonly-owned U.S. Provisional Patent Application No. 61/210,627, filed Mar. 20, 2009, U.S. patent application Ser. No. 12/493,096, filed Jun. 29, 2009, and U.S. patent application Ser. No. 12/885,325, filed Sep. 17, 2010. The contents of each of these patent applications are incorporated herein in their entirety by reference.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to methods for tagging documents and communications with filing and billing information in the context of a secure, online social networking community integrated with a document and communication management tool and billing tool, made up of virtual identities enabled with multiple social networking functionalities, document management functionalities, billing functionalities, and integrative functionalities.

Social networking web sites, such as Facebook.com and MySpace.com, are communities of persons having virtual identities enabled with social networking functionalities. Such sites are often geared towards users having special recreational or social interests such as baseball games, motorcycle riding or dating. There are also social networking web sites for professionals—for example, LinkedIn.com, EsqChat.com and LegallyMinded.com—and some of these sites are communities of persons having virtual identities enabled with social networking functionalities. However, such social networking web sites do not include integration with a secured document management tool, or a tool for voice or video communications, which integration provides synergies in the management of office files and billing records that facilitates more complete, secure, and accurate record keeping.

The prior art also discloses document management systems or tools, meaning systems or tools for managing, creating, editing, deleting, saving, organizing and accessing documents. For instance, Microsoft Office®, more particularly, its Word®, Excel®, and Power Point® applications, allow for creating, editing, deleting, saving and accessing of documents. Microsoft Office® also includes an Outlook® application that allows creating, editing, deleting, saving, accessing, sending and receiving emails. Another prior art system, Interwoven, Inc., offers a document management system that allows for organizing, storing and retrieving documents.

The preceding document management systems are generally examples of stand-alone document systems, most of which are only available as stand-alone systems that require a dedicated network and are not available online. Thus many systems offering document management systems are not available with the type of economies of scale obtainable when offered to a larger community online. Some systems provide some functionalities of a document management system in an online context. For instance, Google.com and OpenOffice.org offer applications for creating, editing, deleting, saving and accessing documents in an online context, and for creating, editing, deleting, saving, accessing, sending and receiving emails in an online context. For instance, HyperOffice.com offers an online document organization system for organizing, storing and retrieving documents online. However, such document management systems that operate in an online context are not offered in the context of integration with a networking community made up of virtual identities enabling social networking functionalities, enhanced with the integrative functionalities described below.

Thus, the prior art lacks a means to allow a user to enable a single online virtual identity, via entry of a single username and password, that allows the user to manage documents and billing records in multiple secure online document management databases, where each document management database is shared by a different organization (or other group of users), and where each organization desires to keep documents confidential to the organization secure from and inaccessible by the other organizations as a whole. The prior art also lacks a means to integrate those documents with an organizations billing or time tracking system, as described below.

The prior art also discloses time tracking or billing tools, meaning a tool for creating, deleting, editing, storing, tracking, recording, and otherwise managing billing entries. The billing entries generally relate to the amount of time spent by a particular user on a particular task, assigned to a particular client or client matter. For instance, ProLaw® is a well-known billing tool used by law firms and other professional organizations to organize, track and record time spent by employees on particular projects. Another prior art billing tool, DTE® offers similar features whereby a user can organize, track, and record time spent on projects. In each of these prior art systems, the user is responsible for inputting a unique identifier to identify the client, the project or matter for that client, the number of hours (or portions of hours) spent on that project, a description of the project, the day that the hours were worked on that project, and other parameters, as necessary and as determined by the organization using the system. These records from multiple users within the organization are typically combined at the end of the month in order to prepare bills or invoices to clients.

The preceding billing or time management systems are examples of stand-alone systems, most of which are only available as stand-alone systems that require a dedicated network and are not available online. In some instances, such as with DTE, some aspects of the time management system are accessible via the web, albeit still as a stand-alone system. In other words, even when accessible online, the time management systems are not offered in the context of integration with a networking community made up of virtual identities enabling social networking functionalities, enhanced with the integrative functionalities described below.

The prior art also discloses internet telephony and audio-visual communications systems or calling tools, such as those using Voice Over Internet Protocol (VoIP), or those that provide video chat services. Examples of these services include Skype, Vonage, Google video chat, ooVoo. These services make use of the internet to transmit audio and, sometimes, video signals to other users on the service.

However the prior art audio and video communications systems and calling tools work, they suffer from a lack of integration with other online networking functionalities available to the user. For example, a user making a call using internet telephony is not able to automatically associate the call made, along with the meta data for that call (such as time of call, length of call, etc.), to any matter that the user is working on. Thus, if the user makes a call using the prior art tools as part of a business endeavor, the user is obliged to make a record of that call using a separate billing or time tracking system (such as those described above), or to otherwise record the call on his own. In many cases, the user will not make a record of the call at all.

Thus there remains a need for a method and system which effectively combines or integrates these online business tools in the context of a social network. In the context of the social network, a user can create a document, and automatically associate the creation of that document with a particular client project (or client matter) at the time of creation. Likewise, a user who makes a call related to a client project can automatically associate that call, including the data associated with that call, with a client project number. Through this integration of these separate systems or tools, the social network user is able to more accurately record time spent working, associate that time entry with actual work product created during the time working, and even associate that time to communications, including email and telephone calls, made in connection with the project.

### BRIEF SUMMARY OF THE INVENTION

The future of web-based computing is rapidly taking shape. Emerging trends include such concepts as cloud computing and Web 2.0, in which a web or cloud-based infrastructure designed for rapid delivery of computing resources is made available through either a public or private provider. While many definitions of these concepts exist, the next generation of computing architecture will focus on delivering business and consumer services with a user focus, designed to encourage rapid innovation and efficient, collaborative decision making. Many market participants are actively trying to develop a dominant online portal for cloud computing, although none has yet done so.

The present invention describes an integration of cloud computing-based services through a portal that combines social networking functionalities with document management tools (such as is described in patent application Ser. No. 12/575,442 incorporated by reference herein), billing or time tracking tools, and audio-visual communications or calling tools available only to members of a network and further enhanced with integrative functionalities as described herein.

The present invention discloses a secure, network-based collaborative work environment in which one or more members of an online community having virtual identities enabled with a plurality of social networking functionalities, document management functionalities, audio-visual communications functionalities, and time tracking or billing functionalities and are able to access and utilize a variety of integrative functionalities as fully described herein. The integrative functionalities include, but are not limited to:

automatically creating a time tracking entry (including an incomplete or partial draft entries) when creating or editing a document in the context of a social networking website and thereby automatically associating with the document selected information relating to the creation or editing of that document.

automatically creating a time tracking entry (including an incomplete or partial draft entries) when placing a call using internet telephony or video chat services (or any other audio or audio-visual communications means) and thereby automatically associating with the document selected information relating to the call;

automatically associating a preselected set of information to be recorded with each time tracking entry;

automatically prompting the member to enter time tracking information to be associated with the document created or edited (or the call placed) at the conclusion of the activity, where necessary;

The invention further makes use of a “profile tagging tool,” as further explained below. The profile tagging tool automatically associates certain information that is relevant to the member and the particular project or task at hand. For example, by accessing the member's social networking profile (also termed “member profile”), the profile tagging tool would automatically tag or associate relevant information in the member profile (such as the member's name and billing rate, for example) with the current project. This information thus tagged will thereafter be imported into a billing entry for the particular project or document that the member is working on in the context of the social network, as described more fully below. In a preferred embodiment, information associated with a profile by the profile tagging tool is accessible only to members of the network to which the tagged or associated information relates. For example, if a member's profile is tagged with information relating to matter number 0100-0001, only members of the network associated with matter number 0100-0001 would be able to see that tagged information on the member's profile.

A similar tool, termed the “document tagging tool” automatically associates relevant information associated with a document being edited, created, or otherwise interacted with by the member. As an example, when a member creates a word processing document, the document tagging tool would then associate the title of the document, the date of creation, the client on whose behalf the document was created, the particular matter number for which the document was created, among other potentially relevant information. This information specific to that document is then “tagged” for use with billing entries created in accordance with the invention described. In much the same way, the “call tagging tool” will tag relevant information associated with a call (e.g., length of call, call recipient, date of call) made by the member using the calling tools described herein.

A billing tool is also used in the invention described herein. The billing tool is generally known in the art, and is used to create, delete, edit, store, track, record, and otherwise manage billing entries for the member's clients. However, the billing tool of this invention has an advantage over the prior art in that it makes use of the information tagged by the profile tagging tool and document tagging tool to create billing entries containing relevant billing information pertaining to the work done by the member on behalf of the client. The billing tool, billing information, and billing entries are further described below, particularly with reference to FIG. 5.

Other features and advantages of the present invention will become more apparent from the following description of the embodiments, taken together with the accompanying several views of the drawings, which illustrate, by way of example, the principles of the invention.

### BRIEF DESCRIPTION OF THE DRAWINGS

FIG. 1 is a representation of a member's home screen on a graphical user interface from which a member may access document creation and editing programs and communications tools that may be used in accordance with the invention

FIG. 2 is a representation of a graphical user interface for voice calling or video calling tools or applications incorporating the automatic tagging and billing method of the invention.

FIG. 3 is a representation of a graphical user interface for an email creation and editing tool or application incorporating the automatic tagging and billing method of the invention.

FIG. 4 is a representation of a graphical user interface for an electronic messaging tool or application incorporating the automatic tagging and billing method of the invention.

FIG. 5 is a representation of a graphical user interface for a billing entry generated from automatically tagged information associated with documents or communications created by the member.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

In a system described in U.S. patent application Ser. Nos. 12/575,442 and 12/493,096, both incorporated herein in their entirety by reference, and in U.S. Provisional Patent Application No. 61/210,627, as well as U.S. Provisional Patent Application titled System And Method Of Ranking And Searching For Professional Profiles, both incorporated herein in their entirety by reference, a social networking community is described, where the members of the social networking community are professionals such as lawyers, accountants, doctors, bankers, teachers, artists, or any other type of person that provides services to others.

It should be noted that the term “profile” or “member profile” includes a member's public pages or information visible to the public generally, information that is visible only to the member herself, information visible only to other members specified by the member, information visible as specified by the member, and information that may not be visible to other members.

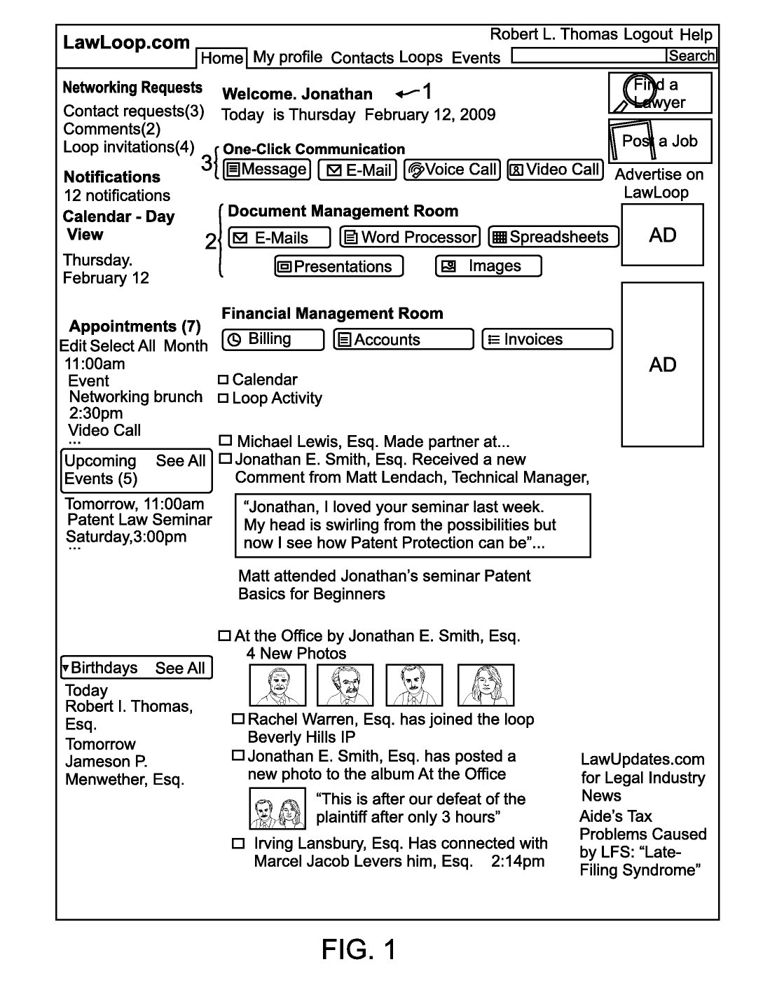

FIG. 1 is a view of a member's 1 home page from which a member 1 may choose to initiate one or more social networking functionalities, such as email programs, word processing programs, spreadsheet programs, presentation programs, or other programs or software 2. Additional social networking functionalities relating to communications options also exist in the context of this invention. From the member's home page, the member 1 may choose to initiate communications via email, electronic messaging, voice calling, video calling, or other means 3. One of skill in the art would understand that the programs or applications available on this home page is not limited to those specifically mentioned here.

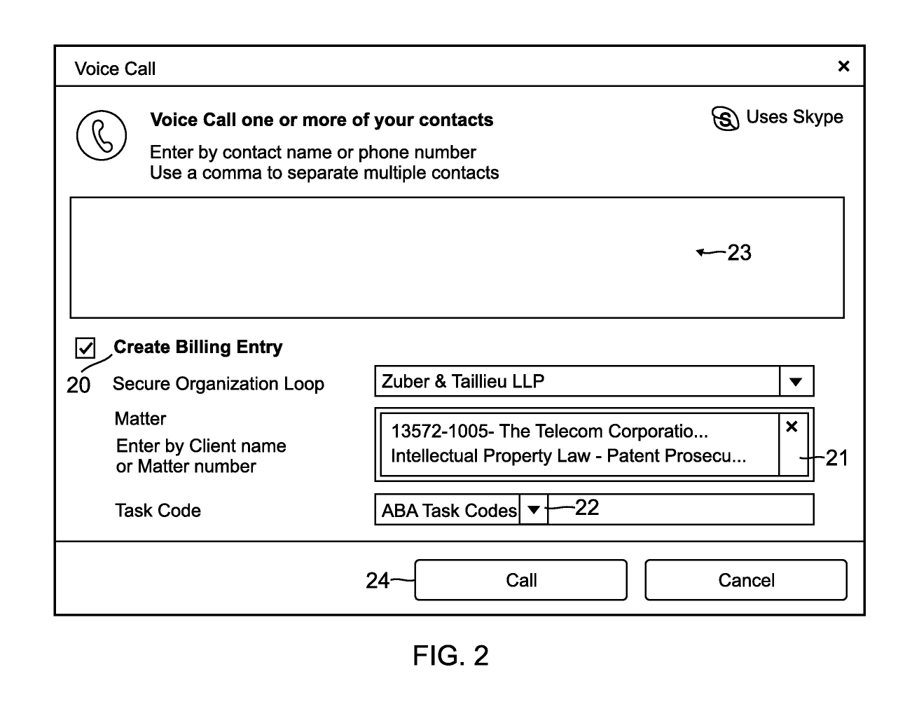

FIG. 2 shows one embodiment of a graphical user interface for the communication programs (such as voice or video calling applications) that may be chosen from the home page. In order to make a voice call, a member would first select the voice calling tool from the home page. Alternatively, the member can click on the phone number or a phone icon on the member profile of a friend or business contact. By clicking on the calling tool or the member's phone number, the social networking calling tool would be activated. In a preferred embodiment, the calling tool would open an internet calling tool such as Skype, which would then pull the member's contact information from the member profile.

The member would next be presented with a graphical user interface as showing in FIG. 2 to create a billing entry automatically in accordance with the invention. In the preferred embodiment, the default for the “create billing entry” check box 20 is selected, indicating that a billing entry will be automatically created each time a call is placed using the voice calling tool within the social networking community. If the member wishes not to create a billing entry for that call, he may do so by unchecking the box 20. The member 1 is asked to confirm or select by way of a drop down menu 21 or similar tool the client information to be associated with this call.

Additional information such as task codes 22 may also be automatically associated with this call from this interface. The task codes may be defined as applicable by members of the network, or they may be adapted from existing task codes. For example, the task codes may be modeled after the American Bar Association's “Uniform Task-Based Management System,” (i.e., “ABA task code”) which can be found at http://www.abanet.org/litigation/utbms/ at the ABA's website.

The member in this embodiment will initiate the call by first inputting a telephone number or selecting a member profile in the contact entry box 23, which will complete a call to a pre-selected phone number tagged to the profile selected and then pressing a submit button 24 to complete the initiation of the call. The member will also preferably select the appropriate task code prior to initiating the call. Alternatively, the appropriate task code or other information may be selected by the member and associated with the call upon completion of the call.

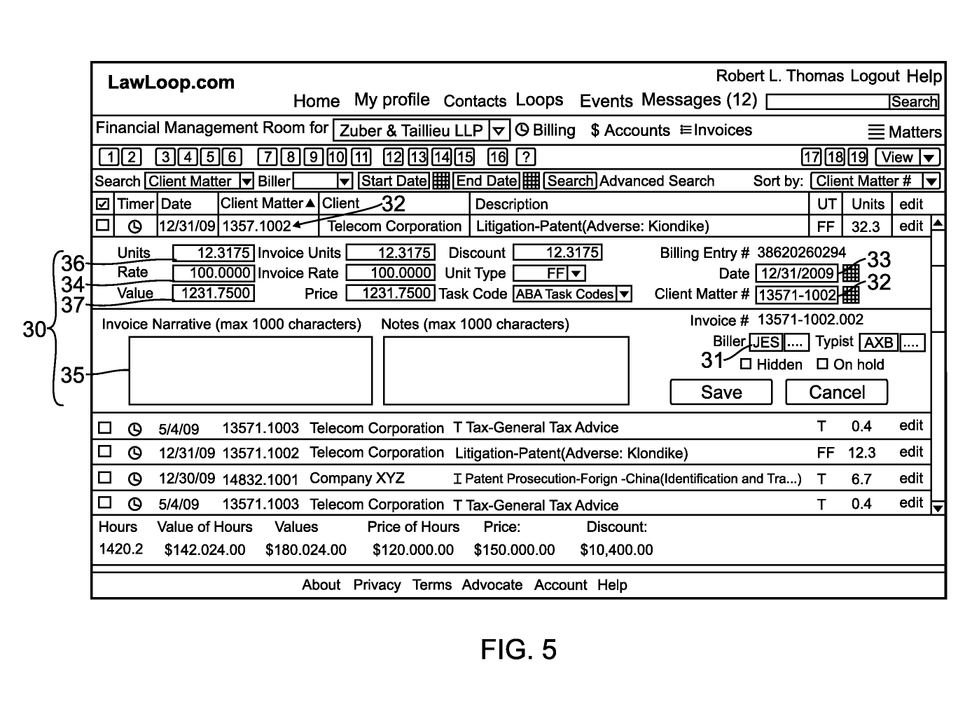

One skilled in the art will understand that the member 1 may wish to input additional information not shown in the figures. It is an object of this invention that the interface be fully customizable as to allow the member 1 to select those data points for automatic tagging and association with bills as will be most beneficial to the member's particular situation. The information selected by the member to be associated with this call will be automatically populated within a billing entry as described below with respect to FIG. 5. One of skill in the art will also appreciate the tagging methods applicable to the calling function are also in large part applicable to other embodiments, a few of which are described throughout this text.

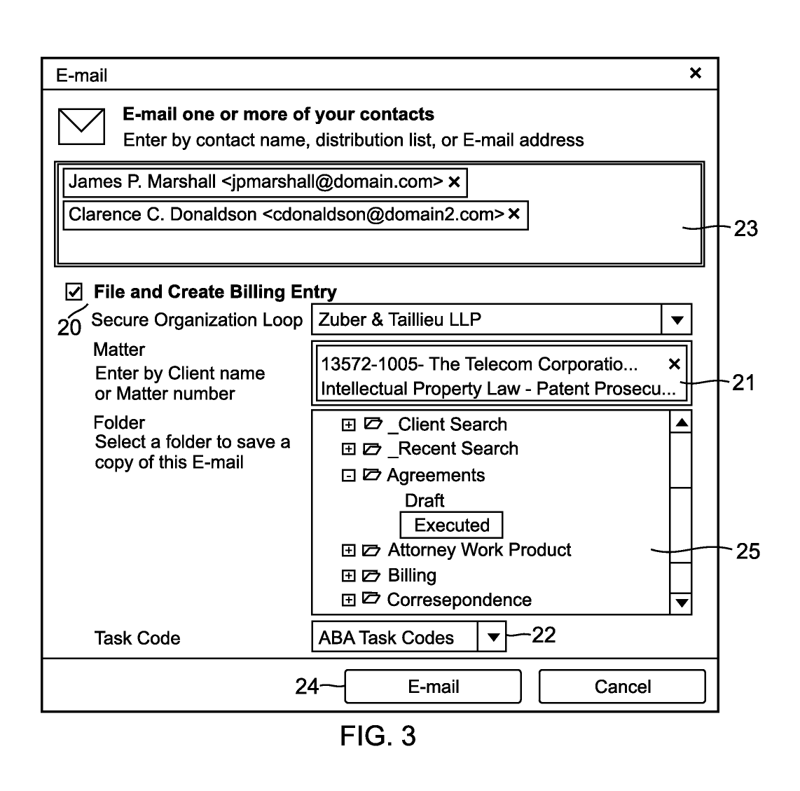

FIG. 3 shows an embodiment of a graphical user interface for an email application in the context of a social networking community in accordance with the invention. A member 1 wishing to send an email using the method of the invention follows the steps as described above with respect to FIG. 2—that is, the member would initiate the email functionality by clicking on the email icon on the member's home page, or by clicking on another member's email address or email icon on said other member's profile. Additionally, in the case of an email, or other document susceptible of electronic organization or filing, the member 1 may choose to associate the email with a folder 25 for organization or document management purposes.

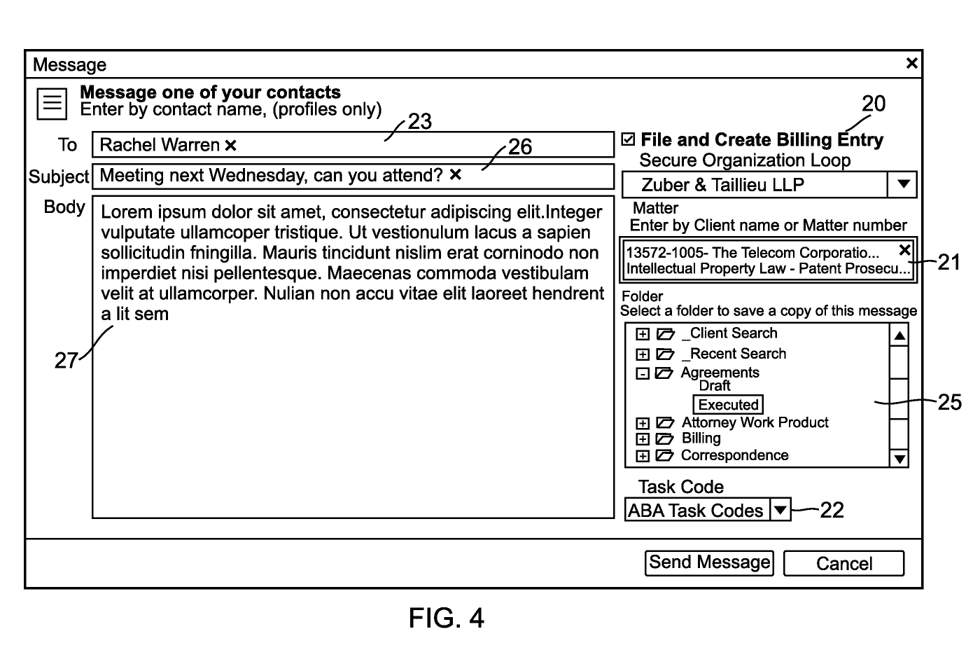

In FIG. 4, the member 1 has initiated a message using an instant messaging program or other electronic messaging platform. In addition to the steps explained in the previous examples, the member 1 may also include a title or subject line 26 for the message as well as the body of the message 27. The text included in the subject line 26 or message body 27 or both are automatically tagged and populated within the billing entry as described below. These additional steps may also be incorporated into the email application described above with respect to FIG. 3.

Additional embodiments associated with the invention will include creation of word processing documents, spreadsheets, image editing or viewing, and other document creation tools, as the member chooses. With respect to such documents, information relating to the documents will be automatically generated based on information associated with the document, such as client identification number and document name. Billing entries associated with word processing documents, spreadsheets, etc. can also be created as described above. Information relating to the document itself if associated by the document tagging tool, and combined with information gleaned by the profile tagging tool to create a billing entry.

The automatic billing prompt in FIG. 5 is generated by the billing tool as it automatically extracts information tagged by the profile tagging tool and the document tagging tool and creates a billing entry with billing information associated with the member and the created or edited document. In the case of a voice call or video call, the automatic billing prompt appears upon clicking an icon to make a call. Similarly, the billing entry associated with an email or electronic message appears upon the member initiating the message. With respect to creation or editing of word processing documents, spreadsheets, or other such documents, the billing entry appears automatically upon first saving of the document.

In this example, the billing information that is automatically extracted and associated by the document tagging tool would include the client name, matter name, client matter number 32, document description, and ABA task code. The profile tagging tool would associate the member's name 31, and billing rate 34. This information is then integrated by the billing tool and automatically imported into the billing entry to fill in the dialogue boxes 30.

In the preferred embodiment, information that is automatically associated and imported into the billing entry is highlighted or otherwise delineated as an automatic entry. The automatically created billing entry might be highlighted in yellow, shaded gray, marked with a red “X” or in some other manner that signifies that the entry was automatically created.

With the automatically associated billing information in place, the billing entry is in a pending state. In a preferred embodiment, the automatically created entry is by default placed in a locked state, with a checkbox or other feature signifying that the entry is in the default locked state. In the state, the member is prevented from releasing the entry until each item of information has been confirmed by the member. Confirmation can be accomplished by checkboxes, tabbing through each entry, or by any other means consistent with allowing the member to verify each entry.

Prior to finalizing the entry, it is likely that the member will also be required to input additional information that the billing tool was unable to automatically capture. For example, although a partial description or invoice narrative 35 might be automatically created in some situations (as described above), it is contemplated that there are situations where the invoice narrative would be more easily or more properly created by the member, rather than automatically by the system. Another example of information that would need to be entered by the member would be the duration of the work performed 36, as the amount of time actually spent editing a document is often not properly calculated simply by referring to the amount of time that the document was open for editing by the member.

Creation or editing of documents presents a unique set of circumstances and information that is not necessarily present in the communication examples described above. For example, unlike a telephone call, a member might return several times to the same document to edit that document Likewise, other members of the network might collaborate on the document—adding, deleting, or otherwise modifying the document. Despite all this, the core information associated with the document by the document tagging tool will not change. The client name, matter name, client-matter number, task code, and folder will not change, no matter how many times that document is revisited. In this manner, billing entries relating to this document can be tagged and managed in a consistent way across several different users and as weeks or months pass.

For example, in the case of an email, the automatic billing prompt would appear with several dialogue boxes 30 already tagged based on information gleaned from the profile tagging tool or the document tagging tool. Additional information would be input by the member. In this situation, the profile tagging tool would take information from the member's profile and automatically associate billing information such as the member name 31, client identification number 32, date 33, billing rate 34, and narrative 35 with the billing entry. The billing rate 34 may be automatically created based on the member's particular rate for that client, as indicated in the member profile for the member. In the case of an email, the narrative 35 is automatically created by importing data for the email recipients and email subject matter from the email message and from the member profiles of the sender and recipients of the email, where possible.

As an example, if the member Robert Thomas were to send an email to another member named James Marshall, Thomas would do so by clicking on Marshall's email address on Marshall's member profile, or by selecting the email function on Thomas' home page, as shown in item 2 of FIG. 1. In either case, Thomas would then compose the email using the social networking email functionality. The profile tagging tool and document tagging tool would then tag information relevant to that email for importing into a billing entry. The profile tagging tool would supply identification information for Thomas and Marshall, as well as client name, matter name, and client matter number associated with Thomas and Marshall. The document tagging tool would supply information such as the subject matter of the email, folder information (item 25 in FIG. 3), task codes (item 22), and date. This information would be automatically created and highlighted in the billing entry. In the example here, the narrative 35 might say “Compose email to James Marshall re: Acme sales pitch” based on the recipient's name and the subject of the email (“Acme sales pitch”). The member may edit the template used to create the narrative as is most appropriate for the member's business or needs. Additionally, the member may edit the automatically created narrative or any other automatically filled field as the member deems appropriate or desirable in each case.

The set of information to be recorded is fully customizable by the member, and can vary from project to project, or from social network to social network. Examples of the information that might be preselected for recording includes the date of the call, identification information (such as name, address, telephone number, etc.) relating to the member making the call, identification information relating to a client, identification information relating to a matter, identification information relating to a folder, a task code, the billing rate of the member making the call, identification information relating to a call participant, and the length of time of the call. This list is not exhaustive, but is intended to demonstrate information that is likely to be recorded in most instances. Those skilled in the art would understand that there are any number of data points that might be automatically created and associated with the creation or editing of documents. The invention contemplates that the member would be able to custom create additional data sets to be automatically captured based on the needs of the member or the member's client.

Because there are certain aspects of each activity that are not automatically ascertainable, the invention contemplates prompting the member to input additional information as necessary. In the case of an email entry or creation of a word processing document, for example, the member may need to indicate the duration 36 of the activity. The invention contemplates automatically calculating the total value to be billed 37 by multiplying the member's 31 billing rate 34 by the duration of the activity 36.

A similar process would be followed for each activity, although customized for the activity. In the case of a voice call, for example, the duration of the activity 36 is readily ascertainable and will be automatically tagged to the billing entry based on the length of the call. However, the subject matter of the call will most likely be unknown to the system, requiring the member 31 to add this information to the narrative 35 field. The invention is easily adapted for similar variations in other activities.

In the case of creation or editing of a word processing document, the narrative can be created by the document tagging tool, which will automatically tag and associate relevant information from the document for use in the billing entry. For example, if the document is being created for the first time, the narrative description might begin with the phrase “Draft”; if the document is being resaved (or if a new version of the document is created) the description might begin with the phrase “Revise.” Alternative terms (such as “Write,” “Create,” or “Edit”) may be preselected by the member, as desired.

The remainder of the time entry is automatically imported by the document tagging tool based on the title of the document as indicated by the document title or filename. So for example, the narrative for drafting a letter titled “Correspondence with Acme Corporation” would be automatically tagged and a billing entry created as “Draft correspondence with Acme Corporation.” It is contemplated that the member associated with the entry (or another member with editing privileges) would be able to edit the description as necessary to comply with the corporate or client protocol.

In this embodiment, the set of information to be automatically collected and tagged for billing will vary based on the particular tool, software, or application used, and based on the individual needs of the member or the member's clients. For example, the automatically tagged and collected information could include the date of editing of the document, a client name, identification information relating to a client, identification information relating to a matter, identification information relating to a folder, a task code, the billing rate of the member, a document title, a document type, identification information relating to an email recipient, and identification information relating to a message recipient. This list is not exhaustive, but illustrative of commonly used information that is relevant to the billing entry described.

Although this embodiment describes the automatic tagging and billing of a document created using a word processing program, the invention is also intended to be used in connection with other commonly used office programs such as spreadsheet programs, image editing programs, presentation programs, or email organizing programs. Likewise the invention may be adapted to be used with specialized software or programs used by professionals or service providers. An example of such a specialized program might be an computer aided drafting system used by engineers or architects.

In an alternative embodiment of the invention, the billing entry is presented following creation of a document or communication, but with very little or no information automatically tagged. Instead, the billing entry is automatically presented to the member, but the information (or some subset of the information) is manually entered by the member. This embodiment allows the member to input each billing event by hand, but offers the convenience and accuracy of the immediate billing prompt, and the ability at that point to associate other member profiles with the billing entry and to apply at that point the information that can be gleaned from use of the member profiles and other social networking functionalities.

By integrating commonly used, but separate, information and applications, the invention promotes efficiency and certainty in tracking and recording billing events for professionals and other service providers. As contemplated by the invention, the member is automatically prompted to record the creation of new documents or communications at the time the creation occurs, thus contributing to the accuracy of billing records. Accuracy in this regard is beneficial not only to the member, who often relies on detailed and accurate bills to get paid for work performed, but is also beneficial to the member's clients, who will be assured that the bills more accurately reflect the time spent on each project than the current system of separately creating documents or communications, then later recording the time spent.

Furthermore, by employing an automatic tagging system, the member can be assured that the bills contain accurate information regarding the client to be billed for the work and the nature of the work.

It is to be understood that other embodiments may be utilized and functional changes may be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. For example, a member may include different sets of information to be automatically tagged and billed than are described here. As a practical example, a medical professional may choose to include a diagnosis or prescription field to be automatically created or billed. It is intended that such a combination of fields of information to be automatically tagged and billed would also be within the scope of the invention, even though it is not otherwise spelled out in the specification. It is therefore intended that the scope of the invention not be limited by this detailed description.

1. A method for interactively collaborating within a secure, server-based social networking community, comprising:
a plurality of members, each of such members owning at least one member profile;
at least one network of member profiles that excludes at least one member of the social networking community, whereby members of said network share access to a set of documents in a secured remote environment, such that members not belonging to said network do not have access to said set of documents, and wherein members of said network share a plurality of social network functionalities among themselves;
a document management tool for managing documents comprised of at least one software application chosen from a group consisting of a message application, an email application, word processor application, a spreadsheet application, a presentations application and an images application, whereby the document management tool enables said members of said network to remotely manage documents of said set of documents and wherein the document management tool automatically associates information relating to client identity and matter identity with the document upon filing of the document;
a billing tool for managing billing entries corresponding to one or more of said members; and
a profile tagging tool for tagging at least one of said member profiles with billing information, such that each time at least one of said documents is edited by a member of said network a billing application entry is automatically created, wherein the billing application entry includes said billing information extracted from the profile; and
a document tagging tool for tagging at least one of said documents with said billing information, such that each time at least one of said documents is edited by a member of said network a billing application entry is automatically created, wherein the billing application entry includes said billing information extracted from the document.

2. The method of claim 1, wherein said billing information includes at least one category of billing information selected from the group consisting of: the date of editing of the document, identification information relating to said member, a client name, identification information relating to a client, identification information relating to a matter, identification information relating to a folder, a task code, the billing rate of said member, a document title, a document type, identification information relating to an email recipient, and identification information relating to a message recipient.

3. The method of claim 1, wherein an automatically created billing entry is visually distinct from billing entries that were not automatically created.

4. The method of claim 1, wherein an automatically created billing entry is automatically placed in a locked state, whereby a member must verify the automatically created information before the billing entry is unlocked for creation of a bill.

5. A method for interactively collaborating within a secure, server-based social networking community, comprising:
a plurality of members, each of such members owning at least one member profile;
at least one network of member profiles that excludes at least one member of the social networking community, whereby members of said network share access to a set of documents in a secured remote environment, such that members not belonging to said network do not have access to said set of documents, and wherein members of said network share a plurality of social network functionalities among themselves;
a document management tool for managing documents comprised of at least one software application chosen from a group consisting of a message application, an email application, word processor application, a spreadsheet application, a presentations application and an images application, whereby the document management tool enables said members of said network to remotely manage documents of said set of documents and wherein the document management tool automatically associates information relating to client identity and matter identity with the document upon filing of the document;
a billing tool for managing billing entries corresponding to one or more of said members; and
a document tagging tool for tagging at least one of said documents with billing information, such that each time at least one of said documents is edited by a member of said network a billing application entry is automatically created, wherein the billing application entry includes said billing information, and wherein said billing information is extracted from information automatically created by the document management tool.

6. The method of claim 5, wherein said billing information includes at least one category of billing information selected from the group consisting of: the date of editing of the document, identification information relating to said member, a client name, identification information relating to a client, identification information relating to a matter, identification information relating to a folder, a task code, the billing rate of said member, a document title, a document type, identification information relating to an email recipient, and identification information relating to a message recipient.

7. The method of claim 5, wherein at least one category of said billing information is automatically tagged to the document according to information associated with the folder selected by the member for filing the document.

8. The method of claim 5, wherein an automatically created billing entry is visually distinct from billing entries that were not automatically created.

9. The method of claim 5, wherein an automatically created billing entry is automatically placed in a locked state, whereby a member must verify the automatically created information before the billing entry is unlocked for creation of a bill.

10. A method for interactively collaborating within a secure, server-based social networking community, comprising:
a plurality of members, each of such members owning at least one member profile;
at least one network of member profiles that excludes at least one member of the social networking community and wherein members of said network share a plurality of social network functionalities among themselves;
a calling tool comprised of at least one calling application for managing calls making a call chosen from a group consisting of a video calling application and a voice calling application, whereby the calling tool enables said members of said network to effect calls over the internet;
a billing tool for managing billing entries corresponding to one or more of said members;
a profile tagging tool for tagging at least one of said member profiles with billing information, such that when a member of said network uses the calling tool to make a call, information relating to the member profiles of each member of said network included in said call is automatically extracted such that a billing application entry is automatically created that includes said billing information;
a call tagging tool for tagging at least one of said call with billing information, such that when a member of said network uses the calling tool to manage said at least one of said make a call, said member can tag the call with billing information, information relating to said call is automatically extracted such that a billing application entry is automatically created that includes said billing information; and
wherein all billing information necessary to create said billing entry is automatically extracted without need for additional input from said member.

11. The method of claim 10, wherein said billing information includes at least one category of billing information selected from the group consisting of: the date of the call, identification information relating to said member, identification information relating to a client, identification information relating to a matter, a task code, the billing rate of said member, identification information relating to a call participant, and the length of time of the call.

12. The method of claim 10, wherein an automatically created billing entry is visually distinct from billing entries that were not automatically created.

13. The method of claim 10, wherein an automatically created billing entry is automatically placed in a locked state, whereby a member must verify the automatically created information before the billing entry is unlocked for creation of a bill.

14. The method of claim 10, wherein said billing information includes all of the following billing information: the date of the call, identification information relating to said member, identification information relating to a client, identification information relating to a matter, the billing rate of said member, identification information relating to a call participant, a description of the call, and the length of time of the call.

15. The method of claim 1, wherein said billing information includes all of the following billing information: the date of editing of the document, identification information relating to said member, a client name, identification information relating to a client, identification information relating to a matter, identification information relating to a folder, a task code, the billing rate of said member, a document title, a document type, identification information relating to an email recipient, and identification information relating to a message recipient.

16. The method of claim 5, wherein said billing information includes all of the following billing information: the date of editing of the document, identification information relating to said member, a client name, identification information relating to a client, identification information relating to a matter, identification information relating to a folder, a task code, the billing rate of said member, a document title, a document type, identification information relating to an email recipient, and identification information relating to a message recipient.

17. The method of claim 5, wherein a profile tagging tool tags at least one of said member profiles with billing information, such that each time at least one of said documents is edited by a member of said network a billing application entry is automatically created, wherein the billing application entry includes said billing information extracted from the profile.

18. The method of claim 1, wherein each subsequent interaction with a document that has been tagged with billing information results in a new billing application entry in which the billing information is extracted from previous billing application entries associated with said document.

19. The method of claim 5, wherein each subsequent interaction with a document that has been tagged with billing information results in a new billing application entry in which the billing information is extracted from previous billing application entries associated with said document.
